(19) United States
(12) Patent Application Publication
(10) Pub. No.: US 2013/0284863 A1
(43) Pub. Date: Oct. 31, 2013

(54) Crock Pot Lid Holder and Stand

(71) Applicant: Fritzinger E. Daniel, Tamaqua, PA (US)

(72) Inventor: Fritzinger E. Daniel, Tamaqua, PA (US)

(21) Appl. No.: 13/872,185

(22) Filed: Apr. 29, 2013

Related U.S. Application Data
(60) Provisional application No. 61/640,532, filed on Apr. 30, 2012.

(51) Int. Cl. A47J 47/16

(52) U.S. Cl. CPC A47J 47/16
USPC 248/125.1; 248/121

(57) ABSTRACT

The invention provides a holder and stand for a crock pot lid. The holder and stand comprises a flat base, an extension, and a forked attachment.

### CROSS-REFERENCE TO RELATED APPLICATIONS

This application claims priority under 35 U.S.C. §119(e)(1) from U.S. Provisional Patent Application No. 61/640,532, filed on Apr. 30, 2012, for “Crock Pot Lid Holder and Stand,” the disclosure of which is incorporated herein by reference.

### STATEMENT REGARDING FEDERALLY SPONSORED RESEARCH

Not Applicable.

### BACKGROUND

1. Field of Invention

The present invention relates to holder/stand for lids, and more particularly relates to stands and holders for crock pot lids.

2. Description of Related Art

Many homemakers as well as chefs utilize various utensils and appliances in the kitchen to assist in the preparation and service of food. A slow cooker (i.e., a crock pot) of the type commonly known in the art is an example of a combination kitchen utensil which purposefully cooks and warms food at a low temperature for a predetermined period of time. Given its desired capacity to slow cook and warm a modest amount of food, the crock pot is most notably used and observed at large gatherings, such as conferences, receptions, family meetings and so forth. To facilitate the cooking process and guard against heat-related injuries stemming from splattered foods, most crock pots comprise a cover or lid made from glass or a semi-conductive material. The lid, in most instances, is heavily weighted insofar to fit tightly atop a cylindrical-shaped, heat-equipped reservoir and is geometrically configured to resemble a dome or semi-flatten plate having a handle outwardly extending therefrom.

During the cooking process as well as during moments of serving food, the homemaker or chef is periodically confronted with the requirement of removing the lid from the crock pot and finding a suitable location for the lid while one is gaining access to the food inside. In order to alleviate this concern most effectively, a range of cover handling devices have been developed. The most simplistic device comprises a pot handling glove or pad having insulating characteristics, while a more advanced device comprises a lid holder of the type that can simultaneously engage the lid's handle and sidewall of the cooking utensil. Although this type of handling device still requires one to directly interact with and handle the cover, albeit at a modest level, it does facilitate placement of the lid next to the crock pot, thus suitably serving as a location for the lid.

In accordance with the present invention, applicant has appreciably devised an apparatus comprising a means for holding and supporting the lid to the crock pot in order to allow access to the food inside.

### SUMMARY

The present invention is an adjustable holder and stand for a crock pot lid. One embodiment of the present invention comprises a wide base with an extension rising vertically and perpendicularly from the base. As part of such embodiment, a forked attachment is attached to the top of the extension using a wingnut and bolt. With the wingnut and bolt, the forked attachment can be moved up and down the top of the extension via a through mortise in the extension. The forked attachment is comprised of two prongs which are shaped to hold the crock pot lid in place by sliding the groove created between the crock pot lid and the lid's handle into the rest between the two prongs.

### BRIEF DESCRIPTION OF THE DRAWINGS

FIG. 1 is a perspective view of a crock pot lid holder and stand consistent with the present invention.

FIG. 2 is a perspective view of a crock pot lid holder and stand consistent with the present invention.

### DETAILED DESCRIPTION

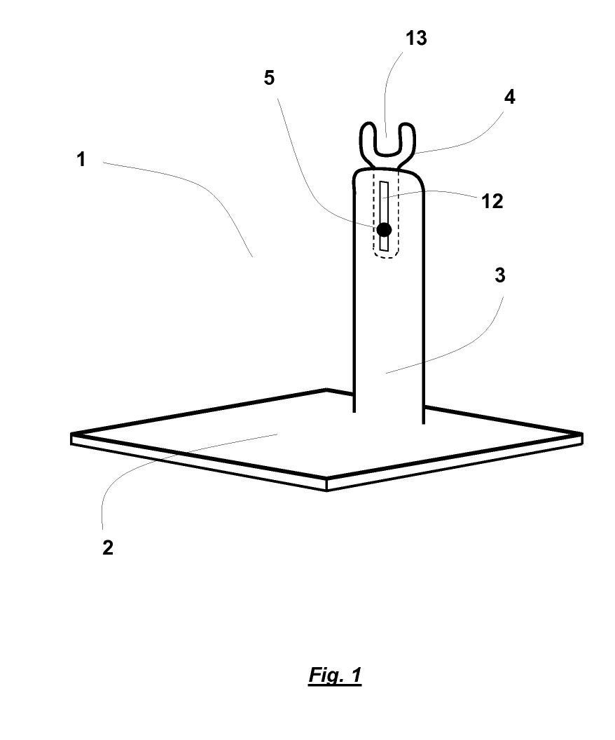

Referring to FIG. 1, the crock pot lid holder and stand 1 is shown in isolation. The holder and stand 1 comprises a flat base 2, an extension 3, and a forked attachment 4. The flat base 2, extension 3, and forked attachment 4 can be constructed out of any solid material such as metal, wood, and/or plastic. The extension 3 is connected to the flat base 2 by any permanent or temporary connection means. In one embodiment of the invention, the extension 3 is welded to the flat base 2. In an alternative embodiment, the extension 3 is attached to the flat base 2 by a mortise and tenon joint. The extension 3 is attached to the flat base 2 in such a way that it extends 90° or nearly-90° from the horizontal plane of the flat base 2. The forked attachment 4 is attached to the top of the extension 3. As shown in FIG. 1, a simple bolt 5 and wing nut are used to attach the forked attachment 4, but any means of attachment can be used, including permanent means such as welding as well as constructing the extension 3 and forked attachment 4 as a singular piece. In certain embodiments of the invention, the forked attachment 4 can be adjusted up and down along the length of the extension 3 through the use of a through mortise 12 cut into the length of the extension 3 as is shown in FIG. 1. The rest 13 created between the prongs of the forked attachment 4 is used to hold the crock pot lid in place.

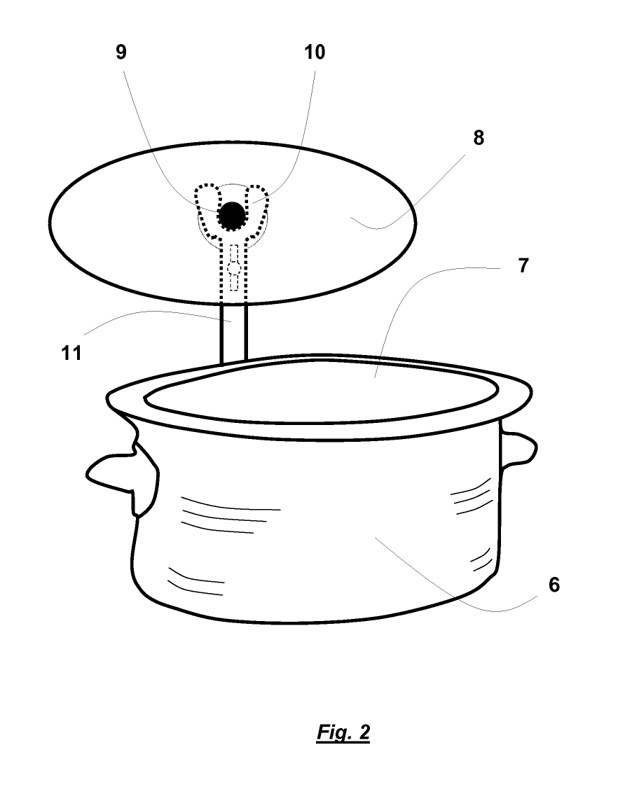

FIG. 2 illustrates the present invention in use. As shown therein, a crock pot 6 is placed on top of the flat stand so that the extension 11 is placed behind the crock pot 6. The lid 8 of the crock pot 6 shown in FIG. 2 is made of glass and is removed from the opening 7. The handle 9 of the lid 8 is then nested onto the rest of the forked attachment 10 as shown in FIG. 2, thereby holding the lid 8 in place over the crock pot 6.

While the invention has been described in conjunction with specific embodiments thereof it is evident that many alternatives, modifications and variations will be apparent to those skilled in the art. Accordingly, the preferred embodiments of the invention, as set forth herein, are intended to be illustrative, not limiting. Various changes may be made without departing from the true spirit and full scope of the invention, as defined in the following claims.

What is claimed is:

1. A crock pot lid holder and stand comprising:
(a) a flat base;
(b) an extension; and
(c) a forked attachment.

2. The crock pot lid holder and stand of claim 1, wherein said extension further comprises a through mortise.

3. The crock pot lid holder and stand of claim 1, wherein said forked attachment further comprises a bolt and wing nut.
